(19) United States
(12) Patent Application Publication
(10) Pub. No.: US 2006/0239359 A1
(43) Pub. Date: Oct. 26, 2006

(54) System, method, and apparatus for pause and picture advance

(76) Inventors: Santosh Savekar, Bangalore (IN); Shivapirakasan Kanakaraj, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/154,326

(22) Filed: Jun. 16, 2005

Related U.S. Application Data
(60) Provisional application No. 60/673,002, filed on Apr. 20, 2005.

(51) Int. Cl. H04N 11/02; H04N 11/04; H04N 7/12; H04B 1/66

(52) U.S. Cl. 375/240.25

(57) ABSTRACT

Presented herein is a system and method for pause and picture advance. In one embodiment, there is presented a method for displaying pictures. The method comprises displaying a first picture at a first vertical synchronization signal; receiving a particular input between the first vertical synchronization signal and a second vertical synchronization signal, the second vertical synchronization signal coming after the first vertical synchronization signal; displaying a second picture at the second vertical synchronization signal; and preventing overwriting of the second picture.

### RELATED APPLICATIONS

This application claims priority to U.S. Provisional Patent Application, Ser. No. 60/673,002, filed Apr. 20, 2005, entitled “SYSTEM, METHOD AND APPARATUS FOR PAUSE AND PICTURE ADVANCE”, by Santosh Savekar, et al. which is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video decoding can be partitioned into two processes—the decode process and the display process. The decode process parses and decodes the incoming bit stream. The decode process decodes the incoming bit stream to produce decoded images. The decoded images contain raw pixel data.

The display process displays the decoded images onto an output screen at the proper time and at the correct and appropriate spatial and temporal resolutions. Display parameters received with the stream indicate the correct and appropriate spatial and temporal resolutions.

A processor executing firmware in Synchronous Random Access Memory (SRAM) implements the decoding and display processes. The processor is often customized, proprietary, and embedded. This is advantageous because the decoding process and many parts of the displaying process are very hardware-dependent. A customized and proprietary processor alleviates many of the constraints imposed by an off-the-shelf processor. Additionally, the decoding process uses many computations. A customized and proprietary processor can usually perform the computations much faster than an off-the-shelf processor.

Customized and proprietary processors have a number of drawbacks. A customized and proprietary processor usually executes firmware stored in SRAM. SRAM is usually expensive and occupies a large area in an integrated circuit. Customized and proprietary processors also complicate debugging. During testing, firmware for selecting appropriate pictures often makes errors, due to bugs. Generally, there are fewer debugging tools for customized and proprietary processors than for off-the-shelf processors. This complicates debugging the firmware for selecting appropriate pictures.

The firmware often makes mistakes during testing because the display process may receive pictures in a different order than the display order. Many compression standards compress pictures by encoding pictures as a set of offsets and displacements from other pictures. Accordingly, some encoded pictures are data dependent on other encoded pictures.

In MPEG-2, a picture can be encoded from one picture displayed before and one picture displayed after. These pictures are known as B-pictures. B-pictures are encoded from reference pictures. Encoded B-pictures are data dependent on the reference pictures. The reference pictures are decoded prior to the B-picture. One of the reference pictures, however is displayed after the B-picture.

During decoding, the decode process decodes pictures and writes the pictures to frame buffers. For B-pictures, there are two reference pictures. The decoding process decodes each reference picture and writes the reference picture to a frame buffer. The decode process decodes the B-picture by referring to the reference pictures in the frame buffer. Another frame buffer stores the B-picture as the decode process decodes the B-picture. Accordingly, decoding MPEG-2 video data uses three frame buffers.

The firmware for selecting appropriate pictures for display can also support various viewing features. The viewing features, known as trick modes, can include fast forward, rewind, pause, and picture advance. Fast forward displays the video data faster than the playback speed. Rewind displays the video data in reverse order. Pausing displays a single picture from the video data for a pause period. Picture advance allows the user to control advancing the pictures in the video data.

The pause and picture advance are useful for examining quickly changing recorded scenes. For example, the pause and picture advance can help determine the causes of rapidly occurring recorded events. A user can examine each individual picture prior to the event. Pausing allows the user to examining a picture for as long as the user desires. When the user has finished examining the picture, the user can use the picture advance. The picture advance allows the user to display and pause the next picture.

Many video decoders use additional frame buffers to support trick modes. Frame buffers are both expensive and consume large areas on an integrated circuit.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein is a system and method for pause and picture advance.

In one embodiment, there is presented a method for displaying pictures. The method comprises displaying a first picture at a first vertical synchronization signal; receiving a particular input between the first vertical synchronization signal and a second vertical synchronization signal, the second vertical synchronization signal coming after the first vertical synchronization signal; displaying a second picture at the second vertical synchronization signal; and preventing overwriting of the second picture.

In another embodiment, there is presented a system for displaying images on a display. The system comprises a first processor and a second processor. The first processor displays a first picture at a first vertical synchronization signal and displays a second picture at a second vertical synchronization signal, the second vertical synchronization signal coming after the first vertical synchronization signal. The second processor receives a particular input between the first vertical synchronization signal and the second vertical synchronization signal and prevents the first processor from overwriting of the second picture.

In another embodiment, there is presented a circuit for displaying pictures. The circuit comprises memory. The memory stores a plurality of executable instructions. The plurality of executable instructions are for displaying a first picture at a first vertical synchronization signal; receiving a particular input between the first vertical synchronization signal and a second vertical synchronization signal, the second vertical synchronization signal coming after the first vertical synchronization signal; displaying a second picture at the second vertical synchronization signal; and preventing overwriting of the second picture.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1a illustrates a block diagram of an exemplary Moving Picture Experts Group (MPEG) encoding process, in accordance with an embodiment of the present invention.

FIG. 1b illustrates an exemplary sequence of frames in display order, in accordance with- an embodiment of the present invention.

FIG. 1c illustrates an exemplary sequence of frames in decode-order, in accordance with an embodiment of the present invention.

FIG. 2 illustrates a block diagram of an exemplary circuit for decoding the compressed video data, in accordance with an embodiment of the present invention.

FIG. 3 illustrates a block diagram of an exemplary decoder and display engine unit for decoding and displaying video data, in accordance with an embodiment of the present invention.

FIG. 4 illustrates a dynamic random access memory (DRAM) unit, in accordance with an embodiment of the present invention.

FIG. 5 illustrates a timing diagram of the decoding and displaying process, in accordance with an embodiment of the present invention.

### DETAILED DESCRIPTION OF THE INVENTION

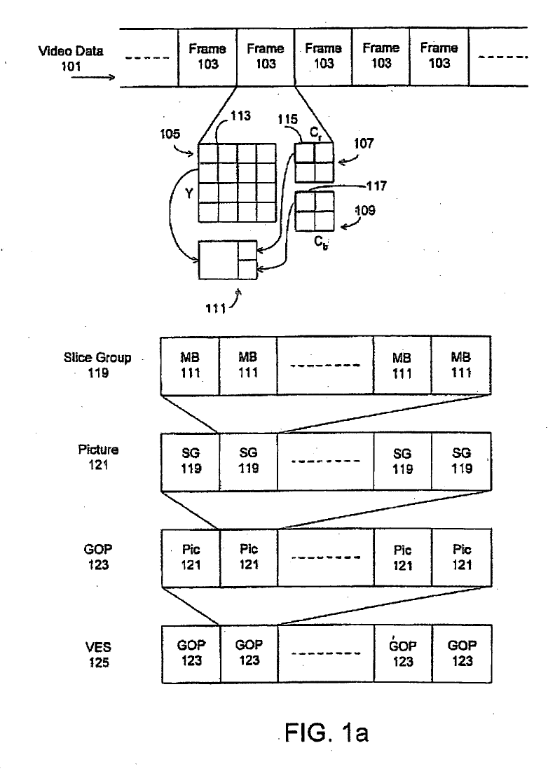

FIG. 1a illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cr, 107, and chrominance blue C_{b}, 109, pixels. The two-dimensional grids are divided into 8×8 blocks, where a group of four blocks or a 16×16 block 113 of luminance pixels Y is associated with a block 115 of chrominance red Cᵣ, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 103 (reference frames). When an appropriate (most similar, i.e. containing the same object(s)) portion of a reference frame 103 is found, the differences between the portion of the reference frame 103 and the macroblock 111 are encoded. The location of the portion in the reference frame 103 is recorded as a motion vector. The encoded difference and the motion vector form part of the data structure encoding the macroblock 111. In the MPEG-2 standard, the macroblocks 111 from one frame 103 (a predicted frame) are limited to prediction from portions of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks ill, as well as additional parameters describing the slice group. Each of the slice groups 119 forming the frame form the data portion of a picture structure 121. The picture 121 includes the slice groups 119 as well as additional parameters that further define the picture 121.

I₀, B₁, B₂, P₃, B₄, B₅, and P₆, FIG. 1b, are exemplary pictures representing frames. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures), for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The foregoing data dependency among the pictures requires decoding of certain pictures prior to others. Additionally, the use of later pictures as reference pictures for previous pictures requires that the later picture be decoded prior to the previous picture. As a result, the pictures cannot be decoded in temporal display order, i.e. the pictures may be decoded in a different order than the order in which they will be displayed on the screen. Accordingly, the pictures are transmitted in data dependent order, and the decoder reorders the pictures for presentation after decoding. I₀, P₃, B₁, B₂, P₆, B₄, B₅, FIG. 1c, represent the pictures in data dependent and decoding order, different from the display order seen in FIG. 1b.

The pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. Each packet is then associated with a transport header, forming what are known as transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

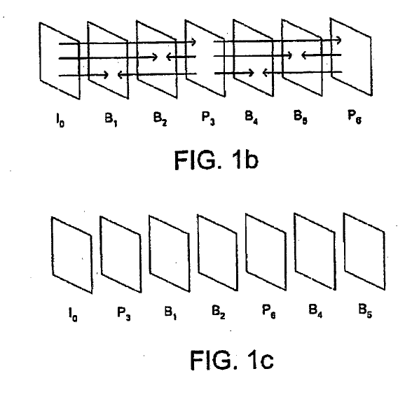

FIG. 2 illustrates a block diagram of an exemplary circuit for decoding the compressed video data, in accordance with an embodiment of the present invention. Data is received and stored in a presentation buffer 203 within a Synchronous Dynamic Random Access Memory (SDRAM) 201. The data can be received from either a communication channel or from a local memory, such as, for example, a hard disc or a DVD.

The data output from the presentation buffer 203 is then passed to a data transport processor 205. The data transport processor 205 demultiplexes the transport stream into packetized elementary stream constituents, and passes the audio transport stream to an audio decoder 215 and the video transport stream to a video transport processor 207 and then to a MPEG video decoder 209. The audio data is then sent to the output blocks, and the video is sent to a display engine 211.

The display engine 211 scales the video picture, renders the graphics, and constructs the complete display. Once the display is ready to be presented, it is passed to a video encoder 213 where it is converted to analog video using an internal digital to analog converter (DAC). The digital audio is converted to analog in an audio digital to analog converter (DAC) 217.

The decoder 209 decodes at least one picture, I₀, B₁, B₂, P₃, B₄, B₅, P₆ . . . during each frame display period, in the absence of PVR modes when live decoding is turned on. Due to the presence of the B-pictures, B₁, B₂, the decoder 209 decodes the pictures, I₀, B₁, B₂, P₃, B₄, B₅, P₆ . . . in an order that is different from the display order. The decoder 209 decodes each of the reference pictures, e.g., I₀, P₃, prior to each picture that is predicted from the reference picture. For example, the decoder 209 decodes I₀, B₁, B₂, P₃, in the order, I₀, P₃, B₁, and B₂. After decoding I₀ and P₃, the decoder 209 applies the offsets and displacements stored in B₁ and B₂, to the decoded I₀ and P₃, to decode B₁ and B₂. In order to apply the offset contained in B₁ and B₂, to the decoded I₀ and P₃, the decoder 209 stores decoded I₀ and P₃ in memory known as frame buffers 219. The display engine 211, then displays the decoded images onto a display device, e.g. monitor, television screen, etc., at the proper time and at the correct spatial and temporal resolution.

Since the images are not decoded in the same order in which they are displayed, the display engine 211 lags behind the decoder 209 by a delay time. In some cases the delay time may be constant. Accordingly, the decoded images are buffered in frame buffers 219 so that the display engine 211 displays them at the appropriate time. Accomplishing a correct display time and order, the display engine 211 uses various parameters decoded by the decoder 209 and stored in the parameter buffer 221, also referred to as Buffer Descriptor Structure (BDS).

The decoder 209 also allows pause and picture advance. Pausing allows a user to display a single picture from the video data for a pause period. A user can initiate pausing by making an appropriate selection from a control panel (not shown).

The control panel can comprise a variety of input devices, such as a hand-held remote control unit, or a keyboard. The control panel provides an input corresponding to the pause function to the decoder 209. The decoder 209 continuously displays a particular picture upon receiving the input corresponding to the pause function.

The user can initiate picture advance after initiating a pause by making another selection from a control panel. The control panel provides an input corresponding to the picture advance function to the decoder. The decoder 209 displays the next picture continuously upon receiving the input corresponding to the picture advance function.

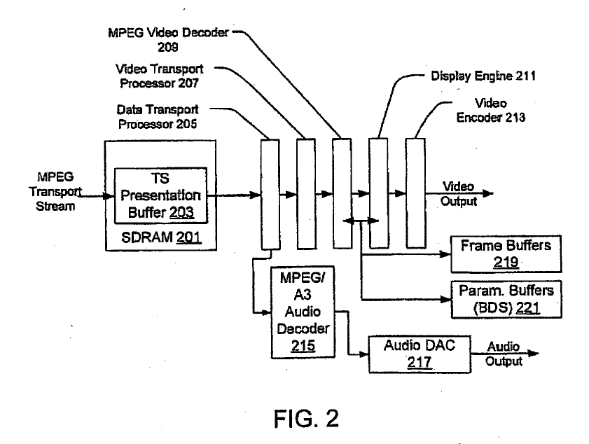

FIG. 3 illustrates a block diagram of an exemplary decoder and display engine unit for decoding and displaying video data, in accordance with an embodiment of the present invention. The decoder and display engine work together to decode and display the video data. Part of the decoding and displaying involves determining the display order of the decoded frames utilizing the parameters stored in parameter buffers.

A conventional system may utilize one processor to implement the decoder 209 and display engine 211. The decoding and display process are usually implemented as firmware in SRAM executed by a processor. The processor is often customized and proprietary, and embedded. This is advantageous because the decoding process and many parts of the displaying process are very hardware-dependent. A customized and proprietary processor alleviates many of the constraints imposed by an off-the-shelf processor. Additionally, the decoding process is computationally intense. The speed afforded by a customized proprietary processor executing instructions from SRAM is a tremendous advantage.

The drawbacks of using a customized proprietary processor and SRAM are that the SRAM is expensive and occupies a large area in an integrated circuit. Additionally, the use of proprietary and customized processor complicates debugging. The software for selecting the appropriate frame for display has been found, empirically, to be one of the most error-prone processes. Debugging of firmware for a customized and proprietary processor is complicated because few debugging tools are likely to exist, as compared to an off-the-shelf processor.

The functionality of the decoder and display unit can be divided into three functions. One of the functions can be decoding the frames, another function can be displaying the frames, and another function can be determining the order in which a decoded frame shall be displayed.

Referring now to FIG. 3, there is illustrated a block diagram of the decoder system in accordance with an embodiment of the present invention. The second processor 307 oversees the process of selecting a decoded frame from the DRAM 309 for display and notifies the first processor 305 of the selected frame.

The second processor 307 executes code that is also stored in the DRAM 309. The second processor 307 can comprise an “off-the-shelf” processor, such as a MIPS or RISC processor. The DRAM 309 and the second processor 307 can be off-chip. The system comprises a processor 305, a memory unit (SRAM) 303, a processor 307, and a memory unit (DRAM) 309.

The code that the second processor 307 executes supports pause and frame advance. The second processor 307 receives the inputs corresponding to the pause and frame advance from the control panel. When the second processor 307 receives the input corresponding to the pause, the second processor 307 continuously selects the currently displayed picture for display. When the second processor 307 receives the input corresponding to the picture advance, the second processor 307 continuously selects the next picture for display.

The first processor 305 oversees the process of decoding the frames of the video frames, and displaying the video images on a display device 311. The first processor 305 may run code that may be stored in the SRAM 303. The first processor 305 and the SRAM 303 are on-chip devices, thus generally inaccessible by a user, which is ideal for ensuring important, permanent and proprietary code cannot be altered by a user. The first processor 305 decodes the frames and stores the decoded frames in the DRAM 309.

The process of decoding and displaying of the frames can be implemented as firmware executed by one processor while the process for selecting the appropriate frame for display can be implemented as firmware executed by another processor. Because the decoding and displaying processes are relatively hardware-dependent, the decoding and displaying processes can be executed in a customized and proprietary processor. The firmware for the decoding and displaying processes can be implemented in SRAM.

On the other hand, the process for selecting the frame for display can be implemented as firmware in DRAM that is executed by a more generic, “off-the-shelf” processor, such as, but not limited to, a MIPS processor or a RISC processor. The foregoing is advantageous because by offloading the firmware for selecting the frame for display from the SRAM, less space on an integrated circuit is consumed. Additionally, empirically, the process for selecting the image for display has been found to consume the greatest amount of time for debugging. By implementing the foregoing as firmware executed by an “off-the-shelf” processor, more debugging tools are available. Accordingly, the amount of time for debugging can be reduced.

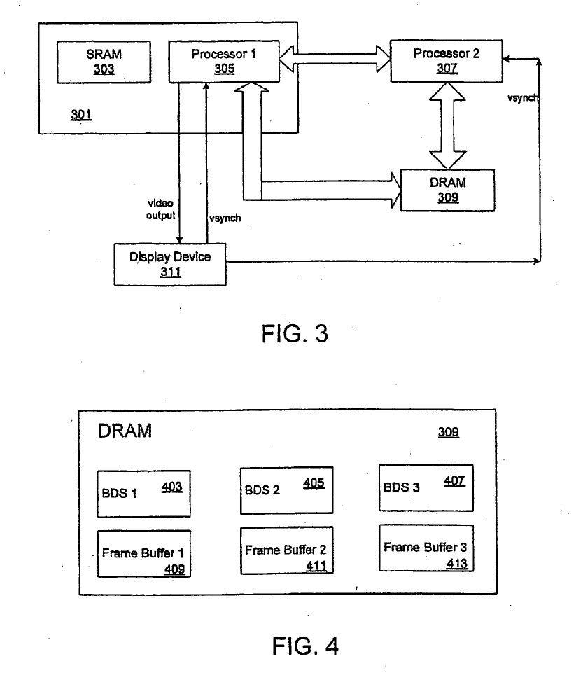

FIG. 4 illustrates a dynamic random access memory (DRAM) unit 309, in accordance with an embodiment of the present invention. The DRAM 309 may contain frame buffers 409, 411 and 413 and corresponding parameter buffers or BDSs 403, 405 and 407.

In one embodiment of the present invention, the video data is provided to the processor 305. The display device 311 sends a vertical synchronization signal (vsynch) every time it is finished displaying a frame. When a vsynch is sent, the processor 305 may decode the next frame in the decoding sequence, which may be different from the display sequence as explained hereinabove. Since the second processor may be an “off-the-shelf” processor, real-time responsiveness of the second processor may not be guaranteed.

To allow the second processor 307 more time to select the frame for display, it is preferable that the second processor 307 selects the frame for display at the next vsynch, responsive to the present vsynch. Accordingly, after the vsynch, the first processor 305 loads parameters for the next decoded frame into the BDS. The second processor 307 can determine the next frame for display, by examining the BDS for all of the frame buffers. This decision can be made prior to the decoding of the next decoded frame, thereby allowing the second processor 307 a window of almost one display period prior to the next vsynch for determining the frame for display, thereat. The decoded frame is then stored in the appropriate buffer.

The process of displaying the picture selected by the second processor prior to the latest vsynch may also be implemented utilizing the second processor. Consequently, the first processor may not need to interface with the display hardware and may work based only on the vsynchs and the signals for determining which frame to overwrite from the second processor.

The processor 307 notifies the processor 305 of the decision regarding which frame should be displayed next. When the display device 311 sends the next vsynch signal, the foregoing is repeated and the processor 305 displays 'the frame that was determined by processor 307 prior to the latest vsynch signal. The processor 305 gets the frame to display and its BDS from the DRAM 309, applies the appropriate display parameters to the frame, and sends it for display on the display device 311.

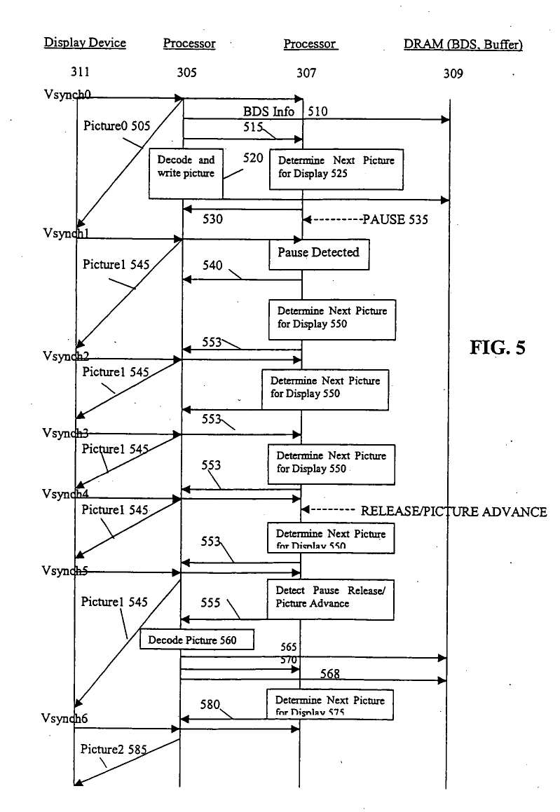

The processors 305 and 307 also support pause and picture advance as will now be described. Referring now to FIG. 5, there is illustrated a timing diagram describing pause and picture advance in accordance with an embodiment of the present invention. At vsynch 0, processor 305 causes the display device to display picture 0 (505).

Responsive to vsynch 0, the processor 305 selects the next picture for decoding. The processor 305 prepares the BDS information, writes the BDS information (510) to the DRAM 309, and signals (515) processor 307 that the BDS is ready. The processor 305 then decodes and writes (520) the next picture in the decoding order.

Responsive to receiving the BDS ready signal, the processor 307 determines (525) the next picture, e.g., picture 1, for display. Processor 307 indicates (530) the next picture for display to processor 305.

Between vsynch 0 and vsynch 1, the processor 307 receives an input (535) corresponding to the pause function. At each vsynch 1, processor 307 polls a number of inputs sources, including input sources associated with the pause and picture advance. If at vsynch 1, the input source associated with the pause provides an input corresponding to the pause, the processor 307 sends a signal (540) indicating the pause to processor 305.

The signal indicating the pause causes the processor 305 to cease decoding the next picture in the decode order and prevents overwriting the display picture. Where there are three frame buffers and consecutive B-pictures are displayed, the processor 305 overwrites the B-picture while the B-picture is displaying. As portions of the B-picture are displayed, the processor 305 overwrites the displayed portions with portions of the next B-picture.

In the case of the pause, the processor 305 displays the picture displayed at vsynch 1, e.g., picture 1, at each subsequent vsynch, vsynch 2, 3, 4 . . . The processor 305 displays picture 1 (545) until the user releases the pause or selects the picture advance. Therefore, processor 305 ceases decoding and does not overwrite picture 1. Processor 307 will select (550) picture 1 for display at each subsequent vsynch until the user releases the pause or selects the picture advance, and notify processor 305 (553).

At each vsynch, processor 307 polls input sources to detect whether the user has released the pause or selected the picture advance. For example, if the user selects the picture advance or releases the pause between vsynchs 4 and 5, the processor 307 detects the foregoing at vsynch 5.

Where the processor 307 detects a picture advance or pause release at vsynch 5, the processor 307 sends a signal (555) indicating the picture advance or pause release to the processor 305. The signal indicating the picture advance or pause release causes the processor 305 to decode (560) the next picture in the decode order. The processor 305 writes the BDS information (565) to the BDS and signals (570) the processor 307 that the BDS is ready. The processor 307 determines (575) the next picture for display at vsynch 5, e.g., picture 2 and indicates (580) the foregoing to processor 305. At vsynch 6, processor 305 causes the display device to display picture 2 (585).

Where the processor 307 detects a pause release, the processors 305 and 307 then continue operation as during vsynch 0. Where the processor 307 detects a picture advance, the signal indicating the picture advance also causes the processor 305 to cease decoding, after decoding the next picture in the decode order. At vsynch 5, the processor 305 and 307 continue operation as during the pause or vsynchs 2 and 3.

The embodiments described herein may be implemented as a board level product, as a single chip, application specific integrated circuit (ASIC), or with varying levels of the decoder system integrated with other portions of the system as separate components.

The degree of integration of the decoder system will primarily be determined by the speed and cost considerations. Because of the sophisticated nature of modern processor, it is possible to utilize a commercially available processor, which may be implemented external to an ASIC implementation.

Alternatively, if the processor is available as an ASIC core or logic block, then the commercially available processor can be implemented as part of an ASIC device wherein certain functions can be implemented in firmware.

While the present invention has been described with reference to certain embodiments, it will be understood by those skilled in the art that various changes may be made and equivalents may be substituted without departing from the scope of the present invention.

In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for displaying pictures, said method comprising:
displaying a first picture at a first vertical synchronization signal;
receiving a particular input between the first vertical synchronization signal and a second vertical synchronization signal, the second vertical synchronization signal coming after the first vertical synchronization signal;
displaying a second picture at the second vertical synchronization signal; and
preventing overwriting of the second picture.

2. The method of claim 1, further comprising preventing video decoding.

3. The method of claim 2, further comprising:
receiving another particular input between a third vertical synchronization signal and a fourth vertical synchronization signal, the fourth vertical synchronization signal coming after the third vertical synchronization signal;
displaying the second picture at the fourth vertical synchronization signal;
decoding at least one picture; and
displaying a third picture at a fifth vertical synchronization signal.

4. The method of claim 3, further comprising displaying the third picture at a sixth vertical synchronization signal.

5. The method of claim 3, further comprising:
preventing overwriting of the third picture.

6. The method of claim 5, further comprising preventing video decoding after decoding one picture.

7. A system for displaying images on a display, said system comprising:
a first processor for displaying a first picture at a first vertical synchronization signal and displaying a second picture at a second vertical synchronization signal, the second vertical synchronization signal coming after the first vertical synchronization signal; and
a second processor for receiving a particular input between the first vertical synchronization signal and the second vertical synchronization signal and preventing the first processor from overwriting of the second picture.

8. The system of claim 7, wherein the second processor prevents the first processor from video decoding.

9. The system of claim 8, wherein the second processor receives another particular input between a third vertical synchronization signal and a fourth vertical synchronization signal, the fourth vertical synchronization signal coming after the third vertical synchronization signal, and wherein the first processor displays the second picture at the fourth vertical signal, decodes at least one picture and displays a third picture at a fifth vertical synchronization signal.

10. The system of claim 9, wherein the first processor displays the third picture at a sixth vertical synchronization signal.

11. The system of claim 9, wherein the second processor prevents the first processor from preventing overwriting of the third picture.

12. The system of claim 11, wherein the second processor prevents the first processor from video decoding after decoding one picture.

13. A circuit for displaying pictures, said circuit comprising memory, said memory storing a plurality of executable instructions, said executable instructions for:
displaying a first picture at a first vertical synchronization signal;
receiving a particular input between the first vertical synchronization signal and a second vertical synchronization signal, the second vertical synchronization signal coming after the first vertical synchronization signal;
displaying a second picture at the second vertical synchronization signal; and
preventing overwriting of the second picture.

14. The circuit of claim 13, wherein the memory stores a plurality of executable instructions for preventing video decoding.

15. The circuit of claim 14, wherein the memory stores a plurality of executable instructions for:
receiving another particular input between a third vertical synchronization signal and a fourth vertical synchronization signal, the fourth vertical synchronization signal coming after the third vertical synchronization signal;
displaying the second picture at the fourth vertical synchronization signal;
decoding at least one picture; and
displaying a third picture at a fifth vertical synchronization signal.

16. The circuit of claim 15, wherein the memory stores a plurality of executable instructions for displaying the third picture at a sixth vertical synchronization signal.

17. The circuit of claim 15, wherein the memory stores a plurality of executable instructions for preventing overwriting of the third picture.

18. The circuit of claim 17, wherein the memory stores a plurality of executable instructions for preventing video decoding after decoding one picture.
